(19) United States
(12) Patent Application Publication
(10) Pub. No.: US 2025/0391159 A1
(43) Pub. Date: Dec. 25, 2025

(54) METHOD FOR DETECTING GARAGE DOOR TEST USING AN ONBOARD VEHICLE CAMERA

(71) Applicant: Honda Motor Co., Ltd., Tokyo (JP)

(72) Inventors: Brian Karl LICKFELT, Powell, OH (US); Kevin C. LAMM, Westerville, OH (US)

(21) Appl. No.: 18/749,081

(22) Filed: Jun. 20, 2024

(51) Int. Cl. G06V 10/776; G01M 99/00; G06V 20/58

(52) U.S. Cl. CPC G06V 10/776; G01M 99/008; G06V 20/58

(57) ABSTRACT

A computer-implemented method for detecting a garage door opener test using a camera located on or in a vehicle. The method includes receiving a video of a garage door opener test associated with a garage door of a garage. The method also includes determining successful completion of the garage door opener test. In response to the successful completion of the garage door test, the method includes enabling an automatic garage door open and close functionality in the vehicle.

### BACKGROUND

This disclosure relates generally to garage door openers, and in particular to a method for detecting a garage door test using an onboard vehicle camera.

Garage doors may be equipped with a door opening and closing mechanism, i.e., a garage door opener, that opens or closes the garage door in response to a signal received from a transmitter. Garage door openers are conventionally equipped with features that prevent the doors from closing on objects or persons. For example, garage door openers have had pinch sensing functionality for decades and photoelectric beam breaking functionality since approximately 1992. These mechanisms help prevent damage to property as well as accidents caused by a garage door closing on a person. The pinch sensing functionality is performed by monitoring motor torque or speed of the door opening and closing mechanism. In the event an unexpected change in torque or speed is detected, the garage door opener will reverse direction. The photoelectric beam breaking mechanism is a light beam which will cause the garage door opener to reverse direction if the beam is broken while the garage door is closing.

Many vehicles now include onboard equipment that allows for in-vehicle control for garage doors, such as HomeLink or other technology from automobile manufacturers. More recently, manufacturers of garage door equipment have introduced technology that allows mobile devices, such as mobile phones, to control the garage door opener operation via Internet of Things (IoT) functionality. Additionally, garage door opening and closing may be operated from the vehicle using mobile telephone connected technology, such as Apple CarPlay or Android Auto. However, these technologies cannot verify that the garage door opener pinch sensing mechanisms and photoelectric beam breaking mechanisms are operating properly before being controlled to operate the garage door opening and closing mechanism.

There is a need in the art for a method for detecting a garage door test using an onboard vehicle camera.

### SUMMARY

In one aspect, a computer-implemented method for detecting a garage door test using an onboard vehicle camera is provided. The method includes receiving a video of a garage door test associated with a garage door of a garage. The method also includes identifying completion of at least a first type of garage door test and a second type of garage door test in the received video using a trained artificial intelligence (AI) test verification module. Upon determining by the AI test verification module that both the first type of garage door test and the second type of garage door test were successfully completed in the received video, the method includes enabling an automatic garage door open and close functionality in a vehicle.

In another aspect, a computer-implemented method for detecting a garage door test using an onboard vehicle camera is provided. The method includes receiving, at a remote server, a request to enable automatic garage door open and close functionality for a vehicle. The method also includes receiving, at the remote server, a video of a garage door test associated with a garage door of a garage from at least one onboard camera of the vehicle. The method further includes identifying completion of at least a first type of garage door test and a second type of garage door test in the received video using a trained artificial intelligence (AI) test verification module at the remote server. Upon determining by the AI test verification module that both the first type of garage door test and the second type of garage door test were successfully completed in the received video, the method includes enabling the automatic garage door open and close functionality in the vehicle.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure may be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic view of an example embodiment of a system for detecting a garage door test using an onboard vehicle camera in accordance with aspects of the present disclosure;

FIG. 2 is a flowchart of an example embodiment of a method for detecting a garage door test using an onboard vehicle camera in accordance with aspects of the present disclosure;

FIG. 3 is a representative view of an example embodiment of an onboard user interface for enabling an automatic garage door open and closing functionality associated with a garage door in accordance with aspects of the present disclosure;

FIG. 4 is a representative view of an exemplary process of detecting a first type of garage door test in accordance with aspects of the present disclosure;

FIG. 5 is a representative view of an exemplary process of detecting a second type of garage door test in accordance with aspects of the present disclosure;

FIG. 6 is a representative view of an example embodiment of an onboard user interface enabling an automatic garage door open and closing functionality associated with a garage door after completion of a garage door test in accordance with aspects of the present disclosure; and

FIG. 7 is a flowchart of an example embodiment of a method for detecting a garage door test using an onboard vehicle camera and a garage sensor or camera in accordance with aspects of the present disclosure.

### DETAILED DESCRIPTION

Current technology allows a user to remotely instruct a garage door opener to open and close a garage door upon receipt of a manual input from the user. However, such technology does not take into consideration autonomous vehicle use cases or expanding the functionality to include automatic opening or closing of the garage door as a vehicle arrives or departs from a garage. For example, U.S. Patent Nos. 10,246,930, 10,358,859, 10,410,448 10,490,007, and 10,557,299, are directed to techniques that allow or permit automatic opening and closing functionality for garage doors. In these cases, a user cannot verify that the garage door pinch sensing mechanisms and photoelectric beam breaking mechanisms are operating properly before the garage door opening and closing mechanism is instructed to open or close the garage door. Previous considerations may only include a disclaimer screen warning of potential danger and asking the user if these mechanisms existed and were in working order.

A method for detecting a garage door opener test using an onboard vehicle camera is described herein. The example embodiments provide a measure that confirms that garage door features to prevent the door from closing on objects or persons are functional and operating properly before enabling automatic garage door opening and closing technology. Specifically, a trained artificial intelligence module is used to detect successful completion of a garage door opener test that evidences proper functioning and operation of garage door pinch sensing and photoelectric beam breaking by a user. Automatic garage door opening and closing operation is only enabled upon successful completion of the garage door opener test. Additionally, video of the successfully completed test may be stored or saved in a database to provide a record of proper garage door functionality.

As used herein, the term “garage” refers to any building, shed or other structure used to house one or more vehicles, including motor vehicles such as cars, buses, motorcycles and trucks.

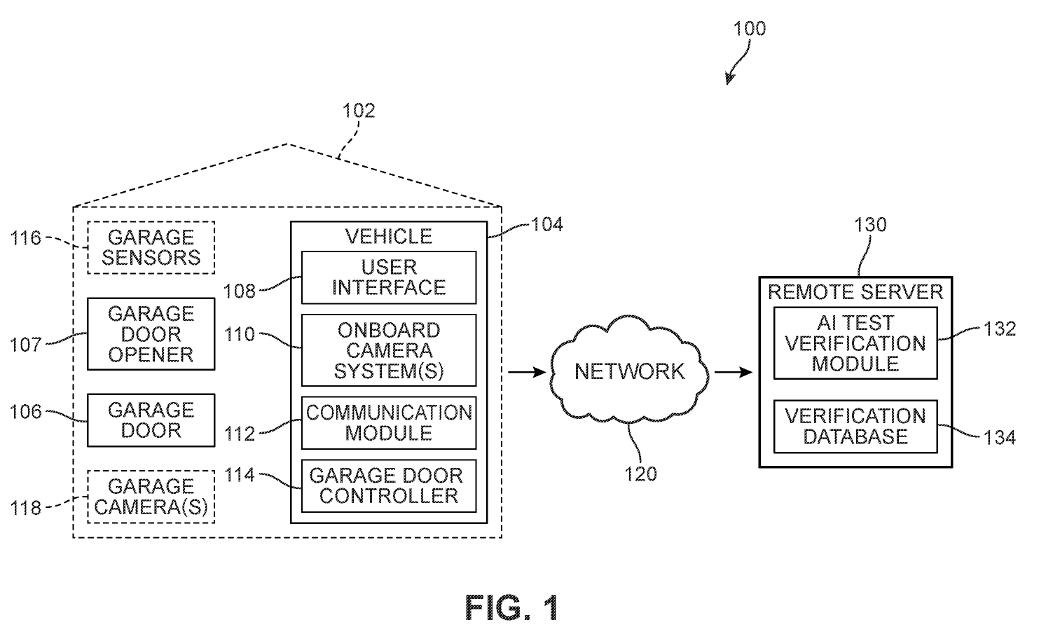

Referring now to FIG. 1, an example embodiment of a system 100 for detecting a garage door opener test using an onboard vehicle camera is shown. In some embodiments, system 100 includes at least one garage 102 that is configured to house or store a vehicle 104. In an example embodiment, garage 102 includes a garage door 106 that controls access to garage 102, for example, by opening to allow entrance to and exit from garage 102 and closing to secure garage 102 from entry. In the present embodiments, garage door 106 may be associated with an open state where entry and exit to garage 102 is permitted and a closed state where entry and exit to garage 102 is not permitted. In an example embodiment, a garage door opener, also referred to as a garage door closing mechanism 107, may control operation of garage door 106 between the open state and closed state.

In an example embodiment, vehicle 104 may enter and exit garage 102 via garage door 106. In various embodiments, vehicle 104 may be any type of vehicle, including but not limited to cars, trucks, vans, motorcycles, scooters, and other types of road vehicles. Additionally, in some embodiments, vehicle 104 may include autonomous and non-autonomous vehicles. In an example embodiment, vehicle 104 may include a user interface 108. In some embodiments, user interface 108 may be configured to allow one or more owners or users of vehicle 104 to interact with various menus and settings of vehicle 104, including selection and input of information associated with functionalities of vehicle 104. Additionally, in some embodiments, user interface 108 may interact with owners or users of vehicle 104 through an application (e.g., mobile app) on a mobile device associated with the owner or user.

In some embodiments, vehicle 104 may include an onboard camera system 110 associated with at least one camera in the vehicle or on the vehicle. For example, many vehicles have one or more cameras located at various locations in and on or around the vehicle, such as dash cameras located inside the vehicle, rear-view cameras located at a rear portion of the vehicle, front-facing cameras located at a front portion of the vehicle, overhead cameras located on or near a roof of the vehicle, side-cameras located on side mirrors or other sides of the vehicle, and/or cameras otherwise associated with the vehicle at other locations on the exterior and/or interior of the vehicle.

In an example embodiment, vehicle 104 may also include a communication module 112. Communication module 112 may be configured to allow a user and/or systems of vehicle 104 to communicate with other users, sensors, vehicles, and others using one or more communication protocols to send and/or receive data, messages, or other information In one embodiment, communication module 112 may include short-range wireless technology, such as Bluetooth®, Wi-Fi, and other short-range wireless communication protocols, for communicating with mobile devices or other electronic devices located within range of the short-range wireless technology. Communication module 112 may also include long-range wireless technology for communicating with other external devices or networks located remotely from vehicle 104. For example, communication module 112 may communicate via external cellular or data networks such as those operating using 5G, LTE, 4G, 3G, or other cellular or data communication protocols as are known in the art. Additionally, communication module 112 may also be capable of receiving information from Global Positioning Satellites (“GPS”), such as position, speed, and/or heading information.

In an example embodiment, vehicle 104 may also include a garage door controller 114. In some embodiments, garage door controller 114 may be configured to control operation of garage door opener 107 to transition garage door 106 between an open or closed state. In an example embodiment, garage door controller 114 may include a wireless transmitter or other short-range wireless technology that sends a signal to garage door opener 107 to open or close garage door 106. For example, garage door controller 114 may include a HomeLink or similar universal garage door controller that is configured to operate many different brands and types of garage door openers. Additionally, in some embodiments, garage door controller 114 may also use cellular or other wireless network technology to control operation of garage door opener 107 remotely, such as from a location that is not within a direct line of sight of garage 102 and which location may be out of range for short-range wireless technology. With this arrangement, garage door controller 114 may be operated to automatically open or close garage door 106 as vehicle 104 arrives or departs from garage 102.

In some embodiments, one or more additional devices may be located in or around garage 102. In an example embodiment, one or more of garage sensors 116 and garage cameras 118 may be located in or around garage 102. For example, in some embodiments, garage sensors 116 associated with garage 102 may include sensors associated with garage door opener 107 that opens and closes garage door 106, motion detection sensors configured to detect movement within garage 102, light sensors configured to detect changes to an amount of light within garage 102, or a combination of one or more of these types of sensors or other suitable sensors that are configured to provide information about garage 102. Garage cameras 118 may include one or more home security cameras located within the interior or around the exterior of garage 102 and/or a camera associated with garage door opener 107 that opens and closes garage door 106.

In an example embodiment, vehicle 104 may include a computing system. The term “computing system” refers to the computing resources of a single computer, the partial computing resources of a single computer, a plurality of computers communicating with one another, and/or a network of remote computers and/or servers. For example, in the embodiment shown in FIG. 1, vehicle 104, specifically communication module 112 of vehicle 104, is connected to a network 120. Communication module 112 of vehicle 104 may communicate with network 120 using any type of wireless communication, including, but not limited to Wi-Fi, cellular, Bluetooth, or any other communication technology. In some embodiments, network 120 may be a local area network ("LAN"), including a wireless local area network (“WLAN”). In other embodiments, network 120 may be a wide area network ("WAN"), including a wireless wide area network (“WWAN”), for example, the Internet. In yet other embodiments, network 120 may be a combination of a WAN and a LAN and may include a combination of wired and/or wireless communication technologies.

Additionally, one or more of garage sensors 116 and garage cameras 118 may be connected to network 120 via a wired or wireless connection. For example, in some cases, garage door sensors 116 and/or garage door cameras 118 may be connected to network 120 via a local network connection using Wi-Fi or other short-range wireless communication technology. In other cases, garage door sensors 116 and/or garage door cameras 118 may be connected to network 120 via a cellular network or other long-range wireless communication technology.

In some embodiments, network 120 may be in communication with at least one remote server 130. In an example embodiment, network 120 may communicate with remote server 130 over the Internet. In various embodiments, remote server 130 may comprise a computing system that includes the computing resources of a single computer, the partial computing resources of a single computer, a plurality of computers communicating with one another, or a network of remote servers.

In an example embodiment, remote server 130 includes one or more processors and/or computing systems embodied in an AI test verification module 132 that uses artificial intelligence (AI) or machine-learning (ML) algorithms and techniques to implement various functions, including, but not limited to: image recognition, object recognition, and/or facial recognition techniques, using image and/or video information obtained from one or more of onboard camera systems 110, garage door sensors 116, and/or garage door cameras 118. In some embodiments, AI test verification module 132 uses AI or ML algorithms and techniques to identify and detect actions in a video that indicate a successful completion or demonstration of a garage door test, as will be described in more detail below.

Remote server 130 may include one or more processors and a non-transitory computer readable medium. Instructions stored on the non-transitory computer readable medium may be executed by the one or more processors to implement the functions described herein, including the AI or ML techniques of AI test verification module 132. Additionally, one or more databases may be co-located with remote server 130 or may be remote databases that are accessible by remote server 130 over network 120. The databases may include any kind of storage devices, including but not limited magnetic, optical, magneto-optical, and/or memory, including volatile memory and non-volatile memory. In one embodiment, the databases may include a verification database 134. Verification database 134 may be used to store video and other information associated with a garage door opener test of garage door 106, including the result as determined by AI test verification module 132, as will be described below.

In an example embodiment, one or more of onboard camera systems 110, garage door sensors 116, and/or garage door cameras 118 may feed information and live or recorded footage to remote server 130, which may include a cloud of servers and backend devices that support AI and ML image recognition by AI test verification module 132 to detect and determine successful completion of a garage door opener test to confirm proper operation of a garage door opener (e.g., garage door opener 107) that opens and closes garage door 106.

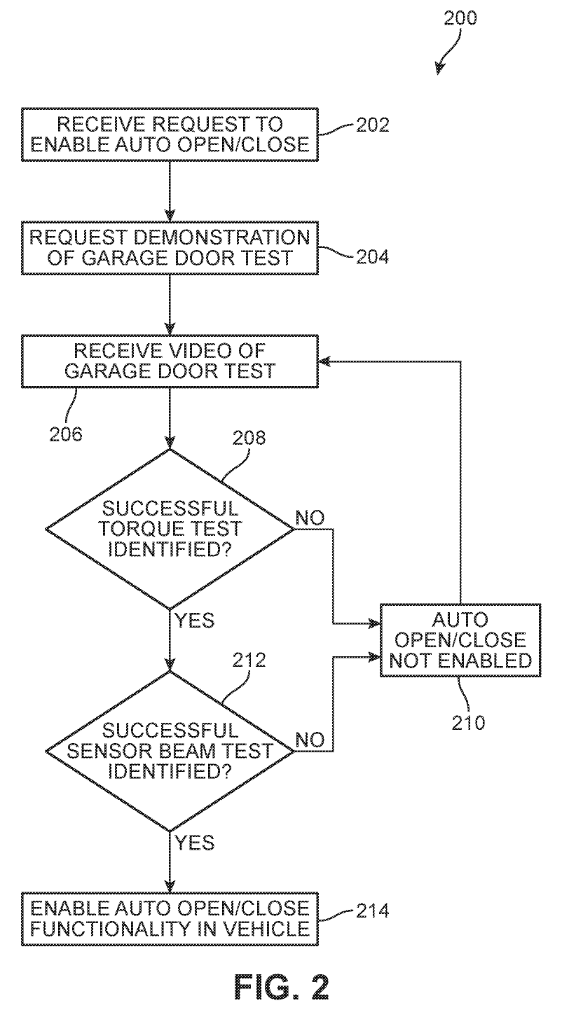

Referring now to FIG. 2, a flowchart of an example embodiment of a method 200 for detecting a garage door opener test using an onboard vehicle camera is shown. According to the techniques described herein, method 200 for detection of a garage door opener test that confirms proper operation of a garage door pinch sensing mechanism and a photoelectric beam breaking mechanism is required in order to enable automatic garage door opening and closing functionality in vehicle 104. In some embodiments, one or more operations of method 200 may be implemented by one or more processors associated with remote server 130 and/or AI test verification module 132.

In this embodiment, method 200 begins at an operation 202. At operation 202, a request to enable automatic open and close functionality for a garage door is received. For example, at operation 202, an owner or user of vehicle 104 may initiate a request to enable automatic garage door opening and closing functionality in vehicle 104 via user interface 108. This request may be transmitted by communication module 112 via network 120 to remote server 130. Next, method 200 includes an operation 204 where a demonstration of a garage door test is requested. For example, at operation 204, remote server 130 may send or transmit the request for the demonstration of the garage door test (e.g., associated with garage door 106) through user interface 108 of vehicle 104. In some embodiments, the request for the demonstration of the garage door test may include instructions for the user to follow to successfully demonstrate the proper functioning of a garage door pinch sensing mechanism and a photoelectric beam breaking mechanism associated with garage door 106. These instructions may be obtained from a manufacturer of the garage door opener associated with garage door 106 (e.g., garage door opener 107) or may be standardized or generic for all or most types of garage door openers.

Method 200 may then proceed to an operation 206. At operation 206 video of the garage door opener test is received. For example, at operation 206 remote server 130 may receive video of the garage door opener test performed by a user and recorded by at least one camera associated with onboard camera systems 110 of vehicle 104. Next, method 200 proceeds to evaluate the video of the garage door opener test to determine whether proper functioning of both a garage door pinch sensing mechanism and a photoelectric beam breaking mechanism may be detected. At an operation 208, whether or not a successful demonstration of a garage door pinch sensing mechanism (e.g., a torque test) is identified in the received video from operation 206 is determined. Detection of the successful demonstration of the torque test to show proper functioning of the garage door pinch sensing mechanism of garage door 106 may be performed using AI test verification module 132 at remote server 130.

Upon determining at operation 208 that the torque test was not successfully identified (e.g., by AI test verification module 132) from the received video (i.e., the result of operation 208 is “NO”), then method 200 proceeds to an operation 210 where automatic open and close functionality for garage door 106 is not enabled for vehicle 104.

Upon determining at operation 208 that the torque test was successfully identified (e.g., by AI test verification module 132) from the received video (i.e., the result of operation 208 is “YES”), then method 200 proceeds to an operation 212. At operation 212, whether or not a successful demonstration of a photoelectric beam breaking mechanism (e.g., a sensor beam test) is identified in the received video from operation 206 is determined. Detection of the successful demonstration of the sensor beam test to show proper functioning of the photoelectric beam breaking mechanism of garage door 106 may be performed using AI test verification module 132 at remote server 130.

Upon determining at operation 212 that the sensor beam test was not successfully identified (e.g., by AI test verification module 132) from the received video (i.e., the result of operation 212 is “NO”), then method 200 proceeds to operation 210 where automatic open and close functionality for garage door 106 is not enabled for vehicle 104.

Upon determining at operation 212 that the sensor beam test was successfully identified (e.g., by AI test verification module 132) from the received video (i.e., the result of operation 212 is “YES”), then method 200 proceeds to an operation 214. At operation 214, automatic open and close functionality for garage door 106 is enabled for vehicle 104. In an example embodiment, automatic open and close functionality for garage door 106 is by default not enabled for vehicle 104 until an owner or user demonstrates successful completion of the garage door opener test according to method 200. Method 200 requires that both the torque test for the garage door pinch sensing mechanism and the sensor beam test for the photoelectric beam breaking mechanism must be successfully identified and detected by AI test verification module 132 at remote server 130 before automatic open and close functionality for garage door 106 is enabled for vehicle 104. In some embodiments, method 200 may further include storing or saving the received video from operation 206 that includes the successful garage door test in verification database 134. With this arrangement, proper operation of garage door opener 107 may be documented prior to enabling the automatic open and close functionality for garage door 106 in vehicle 104.

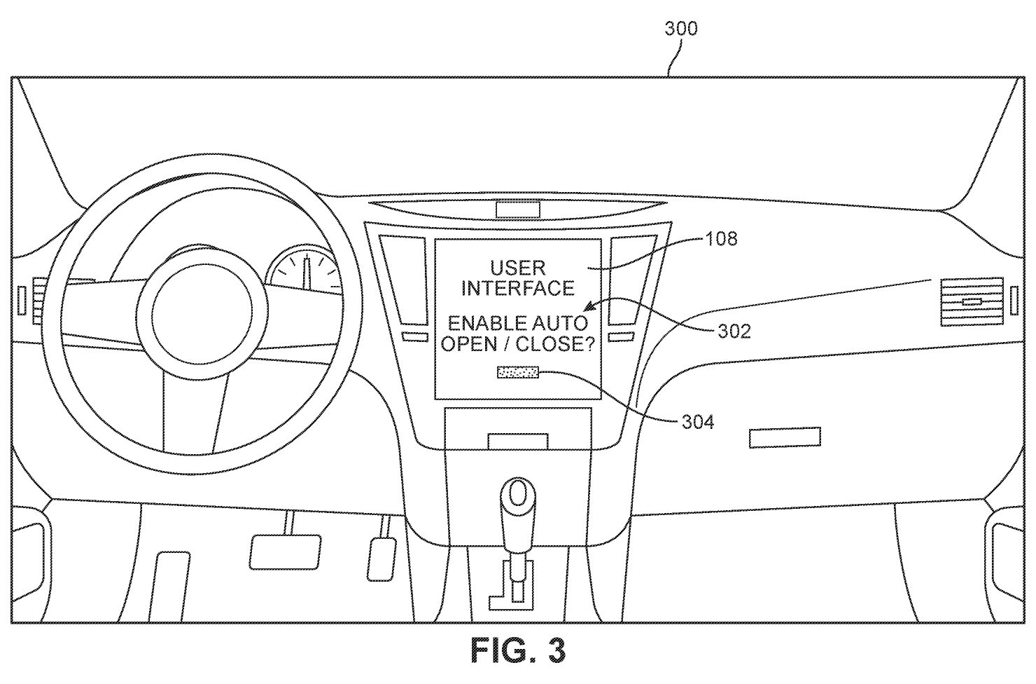

Referring now to FIG. 3, a representative view of an example embodiment of an onboard user interface 108 for enabling an automatic open and closing functionality associated with a garage door is shown. In this embodiment, an interior 300 of vehicle 104 includes user interface 108 that allows an owner or user of vehicle 104 to select an option 302 to enable automatic open and close functionality for garage door 106 in vehicle 104. For example, automatic open and close functionality for garage door 106 would permit garage door controller 114 to automatically open or close garage door 106 based on a proximity of vehicle 104 to garage 102 as well as permit autonomous operation of vehicle 104 to enter or leave garage 102 without human intervention. As shown in FIG. 3, user interface 108 may show option 302 to enable automatic garage door open and close functionality on a display screen. In an example embodiment, automatic garage door open and close functionality for vehicle 104 is in a default state of not enabled until the owner or user chooses to enable it and successfully demonstrates the garage door test as described above in reference to method 200.

In an example embodiment, a selection icon 304 is shown on the display screen of user interface 108 to allow the owner or user to select option 302 to enable. automatic open and close functionality. In some cases, selection icon 304 may be selected by pressing on a touchscreen display or by using one or more input devices, such as buttons, knobs, switches, etc., that are associated with user interface 108. In other cases, user interface 108, option 302 to enable automatic open and close functionality, and selection icon 304 may alternatively or additionally be displayed to the owner or user of vehicle 104 via a paired mobile device, for example, through a mobile application that allows the paired mobile device to communicate with vehicle 104 via communication module 112 using a short-range wireless communication technology. Once the user selects option 302 to enable automatic open and close functionality through user interface 108, the owner or user must demonstrate the garage door opener test as described above in reference to method 200 before vehicle 104 will accept the setting change.

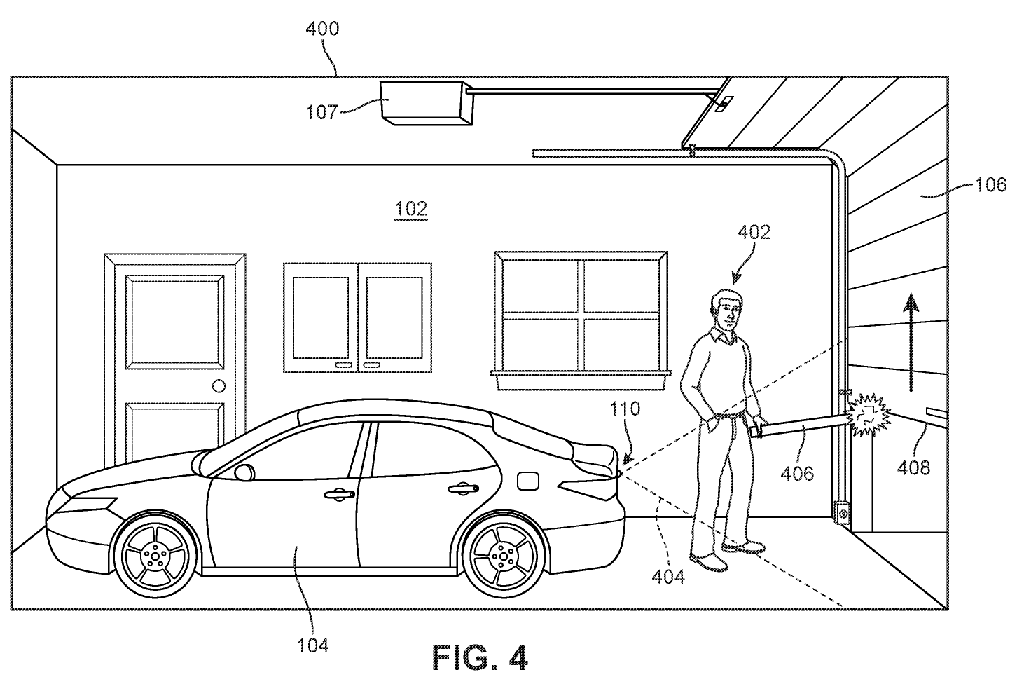

FIG. 4 is a representative view of an exemplary process 400 of detecting a first type of garage door opener test in accordance with aspects of the present disclosure. In some embodiments, the garage door opener test demonstration that is required as part of method 200 to enable automatic garage door opening and closing functionality may include at least two different types of garage door opener tests, including a first type to demonstrate the functionality of a garage door pinch sensing mechanism and a second type to demonstrate the functionality of a photoelectric beam breaking mechanism. As shown in FIG. 4, process 400 illustrates an example embodiment of a torque test to demonstrate the functionality of a garage door pinch sensing mechanism associated with garage door 106. In this embodiment, vehicle 104 is located inside garage 102 with at least one rear-view camera 110 located on a rear portion of vehicle 104. In an example embodiment, rear-view camera 110 on vehicle 104 is configured to capture video and/or images of persons and/or objects that are located behind vehicle 104. For example, rear-view camera 110 may be located above the license plate on the rear portion of vehicle 104 and is configured to display a video or image of an area located behind vehicle 104.

In an example embodiment, process 400 of the torque test to demonstrate the functionality of a garage door pinch sensing mechanism associated with garage door 106 is performed by a user 402. For example, process 400 may be performed as part of method 200 to allow vehicle 104 to enable automatic open and close functionality for garage door 106. As shown in FIG. 4, rear-view camera 110 has a field of view 404 that includes user 402 and garage door 106. In this embodiment, user 402 is performing the torque test to demonstrate the functionality of a garage door pinch sensing mechanism by using an object 406, such as a board or plank, to make contact with a bottom portion 408 of garage door 106. Proper functionality of the garage door pinch sensing mechanism associated with garage door 106 requires that when bottom portion 408 of garage door 106 contacts object 406, garage door 106 reverses direction. In other words, when garage door 106 is in the process of closing and contacts an object (e.g., object 406), the garage door pinch sensing mechanism controls the garage door closing mechanism to stop closing and reverse direction to an open state.

In this embodiment, rear-view camera 110 records video of process 400 of user 402 contacting bottom portion 408 of garage door 106 with object 406 while garage door is closing (i.e., moving in a downward direction towards a closed state) and garage door 106 reversing direction (i.e., moving in an upwards direction to an open state). In an example embodiment, AI test verification module 132 at remote server 130 reviews the recorded video of process 400 to identify a successful completion of the torque test to verify that the garage door pinch sensing mechanism is functioning properly. In some embodiments, AI test verification module 132 may be trained using a plurality of sample or testing videos demonstrating successful and/or unsuccessful operation of the garage door pinch sensing mechanism. For example, AI test verification module 132 may identify user 402, object 406, garage door 106, and bottom portion 408 of garage door 106 in the video recorded by rear-view camera 110. In one embodiment, AI test verification module 132 may determine that the torque test was successfully completed to demonstrate proper functioning of the garage door pinch sensing mechanism when garage door 106 is moving in a downward direction towards a closed state, an object (e.g., object 406) contacts bottom portion 408 of garage door 106 or is within a predetermined minimum distance to bottom portion 408, and, in response to the contact, garage door 106 reverses direction to move in an upwards direction towards an open state. Upon determining these conditions are met, AI test verification module 132 may determine that the torque test successfully demonstrates proper operation of the garage door pinch sensing mechanism, for example, as part of operation 208 of method 200, described above.

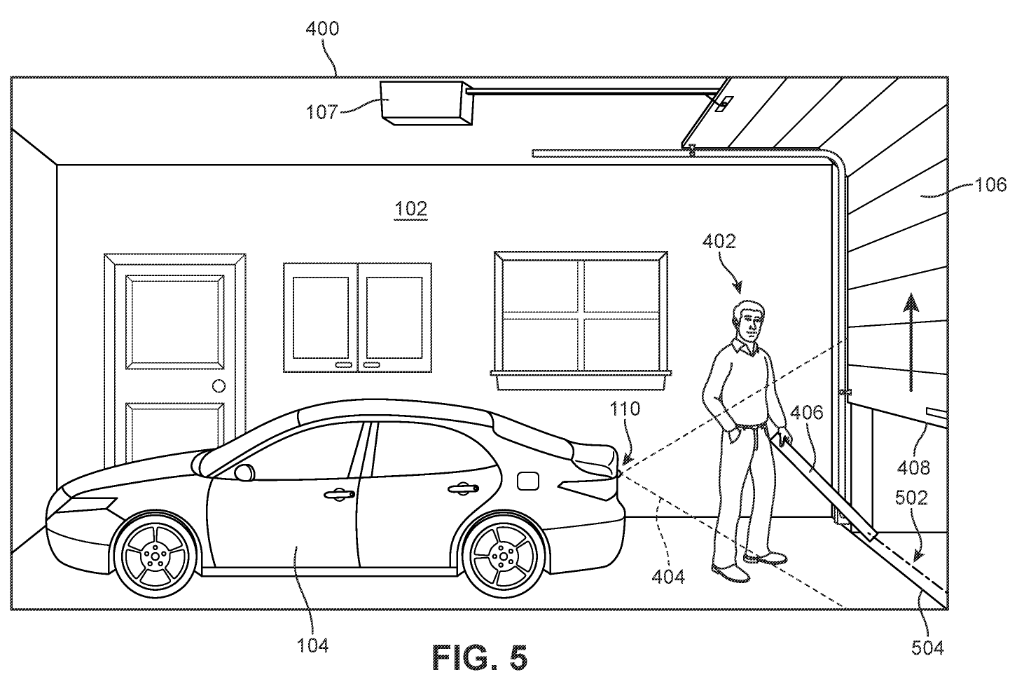

FIG. 5 is a representative view of an exemplary process 500 of detecting a second type of garage door opener test in accordance with aspects of the present disclosure. As shown in FIG. 5, process 500 illustrates an example embodiment of a sensor beam test to demonstrate the functionality of a photoelectric beam breaking mechanism associated with garage door 106. In this embodiment, vehicle 104 is located inside garage 102 with at least one rear-view camera 110 located on a rear portion of vehicle 104. In an example embodiment, rear-view camera 110 on vehicle 104 is configured to capture video and/or images of persons and/or objects that are located behind vehicle 104. For example, rear-view camera 110 may be located above the license plate on the rear portion of vehicle 104 and is configured to display a video or image of an area located behind vehicle 104.

In an example embodiment, process 500 of the sensor beam test to demonstrate the functionality of a photoelectric beam breaking mechanism associated with garage door 106 is performed by user 402. For example, process 500 may be performed as part of method 200 to allow vehicle 104 to enable automatic open and close functionality for garage door 106. As shown in FIG. 5, rear-view camera 110 has field of view 404 that includes user 402 and garage door 106. A photoelectric beam breaking mechanism projects a light beam 502 to a receiver disposed opposite the projecting light source to detect when an object has crossed the light beam, thereby tripping the mechanism to indicate the presence of the object. For example, photoelectric beam breaking mechanism may include a light beam projector that projects light beam 502 across an opening 504 to garage 102 beneath garage door 106. When light beam 502 is interrupted or broken, the photoelectric beam breaking mechanism is triggered so that garage door 106 does not close on an object or person. In this embodiment, user 402 is performing the sensor beam test to demonstrate the functionality of the photoelectric beam breaking mechanism by using object 406, such as a board or plank, to break or interrupt light beam 502 disposed along opening 504 underneath garage door 106. Proper functionality of the photoelectric beam breaking mechanism associated with garage door 106 requires that when object 406 breaks or interrupts light beam 502 from reaching the receiver, garage door 106 reverses direction. In other words, when garage door 106 is in the process of closing and an object (e.g., object 406) moves across opening 504 and breaks light beam 502, the photoelectric beam breaking mechanism controls garage door opener 107 to stop closing and reverse direction to an open state.

In this embodiment, rear-view camera 110 records video of process 500 of user 402 breaking light beam 502 beneath garage door 106 with object 406 while garage door is closing (i.e., moving in a downward direction towards a closed state) and garage door 106 reversing direction (i.e., moving in an upwards direction to an open state). In an example embodiment, AI test verification module 132 at remote server 130 reviews the recorded video of process 500 to identify a successful completion of the sensor beam test to verify that the photoelectric beam breaking mechanism is functioning properly. In some embodiments, AI test verification module 132 may be trained using a plurality of sample or testing videos demonstrating successful and/or unsuccessful operation of the photoelectric beam breaking mechanism. For example, AI test verification module 132 may identify user 402, object 406, garage door 106, and opening 504 under garage door 106 in the video recorded by rear-view camera 110. In one embodiment, AI test verification module 132 may determine that the sensor beam test was successfully completed to demonstrate proper functioning of the photoelectric beam breaking mechanism when garage door 106 is moving in a downward direction towards a closed state, an object (e.g., object 406) passes over opening 504 (i.e., breaking or interrupting light beam 502) beneath garage door 106, and, in response to the interruption, garage door 106 reverses direction to move in an upwards direction towards an open state. Upon determining these conditions are met, AI test verification module 132 may determine that the sensor beam test successfully demonstrates proper operation of the photoelectric beam breaking mechanism, for example, as part of operation 212 of method 200, described above.

In an example embodiment, the recorded video from rear-view camera 110 of one or both of the torque test shown in FIG. 4 to demonstrate functioning of the garage door pinch sensing mechanism and the sensor beam test shown in FIG. 5 to demonstrate functioning of the photoelectric beam breaking mechanism may be stored or saved in verification database 134 at remote server 130 to provide a record or evidence of proper operation of garage door 106. Additionally, in some embodiments, AI test verification module 132 may use facial recognition techniques to identify or verify an identify of user 402. For example, user 402 may be an owner or authorized driver of vehicle 104. In some cases, the identity of user 402 may be saved along with the video of the successful garage door opener tests (e.g., the torque test as shown in FIG. 4 and the sensor beam test shown in FIG. 5) in verification database 134 at remote server 130. In other cases, the face of user 402 may be masked, blurred, or otherwise obscured so that the identity of user 402 may not be recorded or saved with the video. With this arrangement, system 100 may be configured to be in compliance with privacy laws of various jurisdictions.

Although process 400 and process 500 are illustrated in FIG. 4 and FIG. 5, respectively, with vehicle 104 positioned inside garage 102 and using video captured by rear-view camera 110, it should be understood that in other embodiments process 400 and/or process 500 may be performed with a front end of vehicle 104 facing garage door 106 using video captured by a forward facing vehicle camera. Furthermore, process 400 and/or process 500 may be performed with vehicle 104 positioned outside garage 102 using video captured by either rear-view camera 110 or the forward facing vehicle camera, depending on whether the front end of vehicle 104 or the rear end of vehicle 104 is facing the garage door 106.

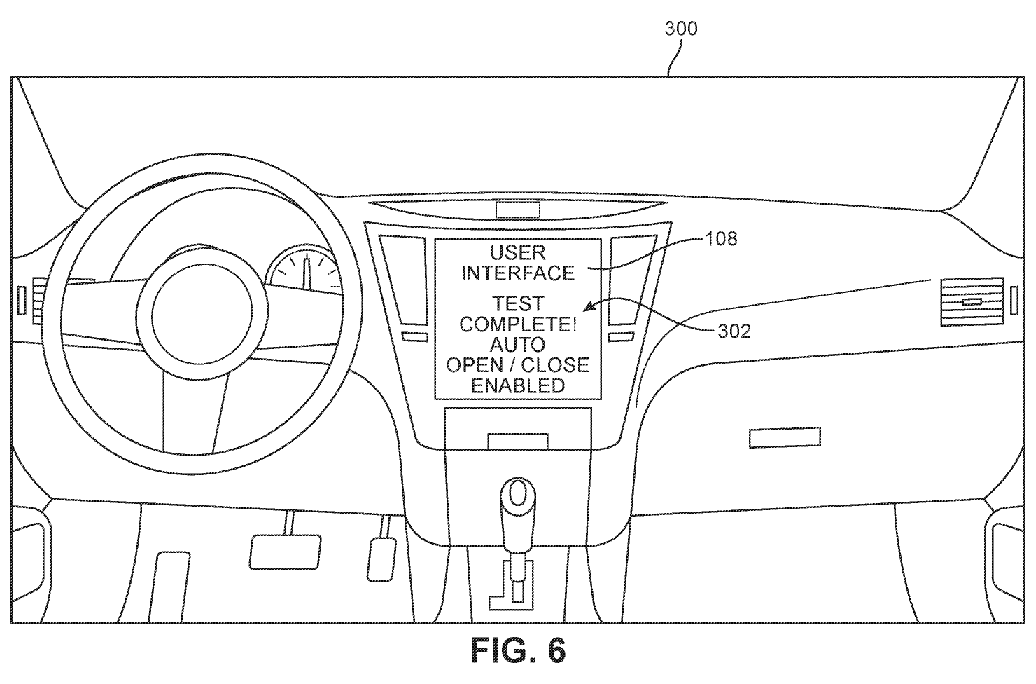

FIG. 6 is a representative view of an example embodiment of onboard user interface 108 enabling an automatic open and closing functionality associated with a garage door after completion of a garage door opener test. Upon successful completion of the torque test and sensor beam test, as described above, AI test verification module 132 may enable automatic open and close functionality for garage door 106 by vehicle 104 as part of operation 214 of method 200. In an example embodiment, AI test verification module 132 at remote server 130 may send a signal or command to an onboard computing system of vehicle 104 that permits vehicle 104 to enable automatic open and close functionality for garage door 106, for example, using garage door controller 114.

As shown in FIG. 6, upon receipt of the signal or command from remote server 130 that enables automatic open and close functionality, user interface 108 within interior 300 of vehicle 104 displays a message 600 to the owner or user that automatic open and close functionality for garage door 106 in vehicle 104 is now enabled. With this arrangement, automatic garage door open and close functionality for vehicle 104 is only enabled upon completion of a successful demonstration of the garage door opener test as described above in reference to method 200.

In some embodiments, one or more additional devices may be located in or around garage 102, including garage sensors 116 and/or garage cameras 118, as described above in reference to FIG. 1. In an example embodiment, information obtained from at least one of these additional devices (e.g., garage sensors 116 and/or garage cameras 118) may be used as an additional check or confirmation that the garage door test was successfully completed by an owner or user before automatic open and close functionality is enabled in vehicle 104.

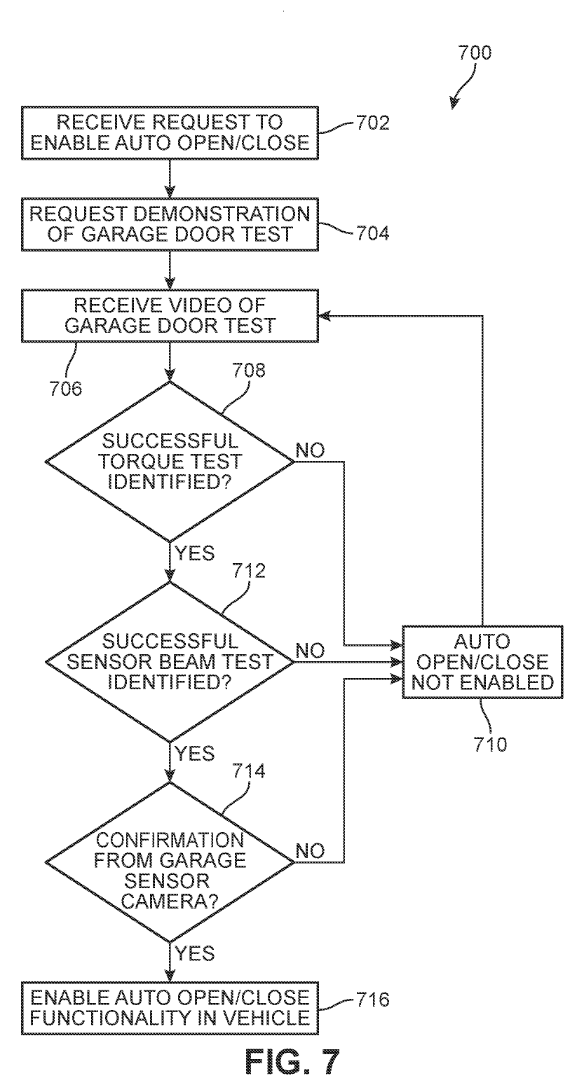

Referring now to FIG. 7, a flowchart of an example embodiment of a method 700 for detecting a garage door opener test using an onboard vehicle camera and a garage sensor or camera is shown. In an example embodiment, one or more operations of method 700 may be implemented by one or more processors associated with remote server 130 and/or AI test verification module 132. In this embodiment, method 700 begins at an operation 702 where a request to enable automatic open and close functionality for a garage door is received. For example, at operation 702, an owner or user of vehicle 104 may initiate a request to enable automatic garage door opening and closing functionality in vehicle 104 via user interface 108. This request may be transmitted by communication module 112 via network 120 to remote server 130. Next, method 700 includes an operation 704 where a demonstration of a garage door opener test is requested. For example, at operation 704, remote server 130 may send or transmit the request for the demonstration of the garage door opener test (e.g., associated with garage door 106) through user interface 108 of vehicle 104. In some embodiments, the request for the demonstration of the garage door opener test may include instructions for the user to follow to successfully demonstrate the proper functioning of a garage door pinch sensing mechanism and a photoelectric beam breaking mechanism associated with garage door 106. These instructions may be obtained from a manufacturer of the garage door opener associated with garage door 106 (e.g., garage door opener 107) or may be standardized or generic for all or most types of garage door openers.

Method 700 may then proceed to an operation 706. At operation 706 video of the garage door opener test is received. For example, at operation 706 remote server 130 may receive video of the garage door opener tests performed by a user and recorded by at least one camera associated with onboard camera systems 110 of vehicle 104, as described above. Next, method 700 proceeds to evaluate the video of the garage door opener test to determine whether proper functioning of both a garage door pinch sensing mechanism and a photoelectric beam breaking mechanism may be detected. At an operation 708, whether or not a successful demonstration of a garage door pinch sensing mechanism (e.g., a torque test) is identified in the received video from operation 706 is determined. Detection of the successful demonstration of the torque test to show proper functioning of the garage door pinch sensing mechanism of garage door 106 may be performed using AI test verification module 132 at remote server 130.

Upon determining at operation 708 that the torque test was not successfully identified (e.g., by AI test verification module 132) from the received video (i.e., the result of operation 708 is “NO”), then method 700 proceeds to an operation 710 where automatic open and close functionality for garage door 106 is not enabled for vehicle 104. Upon determining at operation 708 that the torque test was successfully identified (e.g., by AI test verification module 132) from the received video (i.e., the result of operation 708 is “YES”), then method 700 proceeds to an operation 712. At operation 712, whether or not a successful demonstration of a photoelectric beam breaking mechanism (e.g., a sensor beam test) is identified in the received video from operation 706 is determined. Detection of the successful demonstration of the sensor beam test to show proper functioning of the photoelectric beam breaking mechanism of garage door 106 may be performed using AI test verification module 132 at remote server 130.

Upon determining at operation 712 that the sensor beam test was not successfully identified (e.g., by AI test verification module 132) from the received video (i.e., the result of operation 712 is “NO”), then method 700 proceeds to operation 710 where automatic open and close functionality for garage door 106 is not enabled for vehicle 104. Upon determining at operation 712 that the sensor beam test was successfully identified (e.g., by AI test verification module 132) from the received video (i.e., the result of operation 712 is “YES”), then method 700 proceeds to an operation 714.

At operation 714, whether or not confirmation is received from at least one garage sensor or camera is determined. For example, at operation 714, information from one or more of garage sensors 116 and garage cameras 118 may be sent over network 120 to remote server 130. Remote server 130, including AI test verification module 132, may analyze the received information to detect whether garage door 106 did reverse direction in response to either or both of the torque test and the sensor beam test.

For example, information from garage door opener 107 (e.g., one type of garage sensor 116) may indicate that a motor reversed operation to raise garage door 106 in response to a signal or command from the garage door pinch sensing mechanism and/or the photoelectric beam breaking mechanism. In another example, a light sensing mechanism within garage 102 (e.g., another type of garage sensor 116) may send information to remote server 130 indicating a change in the amount of light inside garage 102 that is associated with garage door 106 reversing direction from closing to opening in response to the torque test and/or the sensor beam test. In still another example, at least one garage camera 118 may record garage door 106 reversing direction from closing to opening in response to the torque test and/or the sensor beam test. In some cases, AI test verification module 132 may analyze the video from garage camera 118 to confirm that garage door 106 reversed direction.

Upon determining at operation 714 that confirmation was not received from at least one of garage sensors 116 and garage cameras 118 (i.e., the result of operation 714 is “NO”), then method 700 proceeds to operation 710 where automatic open and close functionality for garage door 106 is not enabled for vehicle 104. Upon determining at operation 714 that that confirmation was received from at least one of garage sensors 116 and garage cameras 118 (i.e., the result of operation 714 is “YES”), then method 700 proceeds to an operation 716.

At operation 716, automatic open and close functionality for garage door 106 is enabled for vehicle 104. In an example embodiment, automatic open and close functionality for garage door 106 is by default not enabled for vehicle 104 until an owner or user demonstrates successful completion of the garage door opener test according to method 700. Method 700 requires that both the torque test for the garage door pinch sensing mechanism and the sensor beam test for the photoelectric beam breaking mechanism must be successfully identified and detected by AI test verification module 132 at remote server 130 and further requires a confirmation of garage door 106 reversing direction from at least one of garage sensors 116 and garage cameras 118 before automatic open and close functionality for garage door 106 is enabled for vehicle 104. In some embodiments, method 700 may further include storing or saving the received video from operation 706 that includes the successful garage door test in verification database 134, as well as the confirmation received from operation 714. With this arrangement, proper operation of garage door opener 107 may be documented prior to enabling the automatic open and close functionality for garage door 106 in vehicle 104.

The techniques described herein provide a method for detecting a garage door opener test using an onboard vehicle camera. The example embodiments provide a measure to confirm that garage door features that prevent the doors from closing on objects or persons are functional and operating properly before enabling automatic garage door opening and closing technology. The exemplary embodiments utilize a trained artificial intelligence module to detect successful completion of a garage door opener test that evidences proper functioning and operation of garage door pinch sensing and photoelectric beam breaking by a user.

The example embodiments have been described with reference to a garage door and a garage door opener that controls operation of the garage door. In other embodiments, the techniques of the example embodiments may be applied to using cameras associated with a vehicle to confirm operation of mechanisms of other types of vehicle access control devices, including, but not limited to: gates, beams, barricades, bollards, retractable barriers, in-ground traffic spikes, and/or other types of vehicular entry or exit control systems.

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. Also, various modifications and changes may be made within the scope of the attached claims.

1. A computer-implemented method for detecting a garage door opener test using a camera included at least one of in a vehicle or on a vehicle, the method comprising:
receiving a video, from the camera, of a garage door opener test associated with a garage door of a garage;
determining successful completion of the garage door opener test; and
enabling, within the vehicle, an automatic garage door open and close functionality of the garage door opener.

2. The method according to claim 1, wherein the automatic garage door open and close functionality is disabled or not available until a successful completion of the garage door opener test.

3. The method according to claim 1, wherein the camera includes at least one of a rear-view camera and a forward-facing camera.

4. The method according to claim 1, wherein the video from the camera is recorded while the vehicle is inside the garage.

5. The method according to claim 1, wherein receiving the video of the garage door opener test comprises receiving video from a camera associated with a mobile device of a user of the vehicle.

6. The method according to claim 1, wherein the garage door opener test includes a first type of garage door opener test and a second type of garage door opener test.

7. The method according to claim 6, wherein the first type of garage door opener test is a torque test to confirm proper functionality of a garage door pinch sensing mechanism associated with the garage door.

8. The method according to claim 6, wherein the second type of garage door test is a sensor beam test to confirm proper functionality of a photoelectric beam breaking mechanism associated with the garage door.

9. The method according to claim 1, further comprising:
receiving information from at least one garage sensor or garage camera associated with the garage; and
analyzing the received information from the at least one of the garage sensor or garage camera to detect confirmation that the garage door reverses direction in response to the first type of garage door test and the second type of garage door test.

10. The method according to claim 1, further comprising:
storing the received video of the garage door opener test in a confirmation database.

11. The method according to claim 1, wherein a trained artificial intelligence (AI) test verification module is located at a remote server in communication with the vehicle through a network; and
wherein the AI test verification module determines successful completion of the garage door opener test from the received video.

12. A system for enabling automatic garage door open and close functionality for a vehicle comprising:
a user interface associated with a vehicle configured to receive, from a user,
a request to enable automatic garage door open and close functionality for the vehicle;
a display screen associated with the user interface configured to provide instructions to the user for performing a garage door opener test for a garage door of a garage;
at least one camera in the vehicle or on the vehicle configured to capture video of the garage door opener test performed by the user;
a processor configured to receive the video of the garage door opener test and determine successful completion of the garage door opener test to enable automatic garage door open and close functionality for the vehicle.

13. The system according to claim 12, wherein the user interface is disposed within the vehicle.

14. The system according to claim 12, wherein the user interface is associated with a mobile device of the user.

15. The system according to claim 12, wherein the instructions for the garage door opener test include a first type of garage door opener test that is a torque test to confirm proper functionality of a garage door pinch sensing mechanism associated with the garage door.

16. The system according to claim 15, wherein the instructions for the garage door opener test include a second type of garage door test is a sensor beam test to confirm proper functionality of a photoelectric beam breaking mechanism associated with the garage door.

17. The system according to claim 12, further comprising:
at least one garage sensor or garage camera associated with the garage configured to capture information associated with the garage or garage door.

18. The system according to claim 17, wherein the processor is configured to analyze the received information from the at least one of the garage sensor or garage camera to detect confirmation that the garage door reverses direction in response to the successful completion of the garage door opener test.

19. The system according to claim 12, further comprising:
a confirmation database located at a remote server configured to store the received video of the garage door opener test.

20. The system according to claim 12, wherein the automatic garage door open and close functionality for the vehicle is disabled or not available until a successful completion of the garage door opener test.
